(19) United States
(12) Patent Application Publication
(10) Pub. No.: US 2026/0079991 A1
(43) Pub. Date: Mar. 19, 2026

(54) SUMMARIZING AND VISUALIZING RESULT DATA USING ARTIFICIAL INTELLIGENCE OR MACHINE LEARNING

(71) Applicant: MicroStrategy Incorporated, Vienna, VA (US)

(72) Inventors: Marta Aleksandra Pietruczuk, Washington, DC (US); Jingbin Zhang, Hangzhou (CN); Tingting Jin, Vienna, VA (US); Divya Singh, Chantilly, VA (US); Qiong Wu, Vienna, VA (US); Haifeng Wang, Vienna, VA (US)

(21) Appl. No.: 19/332,976

(22) Filed: Sep. 18, 2025

Related U.S. Application Data
(60) Provisional application No. 63/696,615, filed on Sep. 19, 2024.

(51) Int. Cl. G06F 16/338; G06F 16/334; G06F 16/34

(52) U.S. Cl. CPC G06F 16/338; G06F 16/3344; G06F 16/345

(57) ABSTRACT

Methods, systems, and apparatus, including computer-readable media, for summarizing and visualizing result data using artificial intelligence and/or machine learning. In some implementations, a system receives a user prompt comprising text that includes a natural language statement from a user. The system obtains code or instructions generated by one or more artificial intelligence and/or machine learning (AI/ML) models to retrieve, from a data source, data specified by the natural language statement in the user prompt. The system retrieves the data from the database system based on the code or instructions, and the system sends a request for the one or more AI/ML models to summarize the retrieved data. The system receives a summary of the retrieved data that the one or more AI/ML models generated, and the system provides (i) visualization data for a visualization of the retrieved data and (ii) the summary of the retrieved data.

### CROSS-REFERENCES TO RELATED APPLICATIONS

This application claims the benefit of priority to U.S. Provisional Patent Application No. 63/696,615, filed on Sep. 19, 2024, the entire contents of which is incorporated by reference herein.

### BACKGROUND

The present specification relates to techniques for summarizing and visualizing result data using artificial intelligence or machine learning.

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system uses artificial intelligence or machine learning (AI/ML) models to generate data visualizations and summaries of result data, such as results obtained in response to user prompts to a chatbot. The system can generate accurate, high-quality visualizations and summaries using a process that leverages the capabilities of AI/ML models, such as large language models (LLMs), as well as the capabilities of data processing systems, such as database management systems. For each visualization generated, the system can use multiple interactions to combine repeatable, accurate data retrieval of a data processing system with the generative and inference capabilities of an AI/ML model.

The system can provide an AI/ML chatbot system the ability to summarize data visualizations in a way that varies how answers are provided. This includes techniques for generating histograms as outputs of AI/ML chatbots. Many existing AI/ML systems fail to provide accurate or precise answers when dealing with large data sets. The capability to generate a histogram in response to a user's question or prompt to a chatbot can show nuanced relationships and distribution information that many large language models abstract away or ignore. The system can analyze the user prompt, the result set generated in response to the user prompt (e.g., results retrieved from a database system), or both, to determine whether the result set can be represented in a histogram visualization. For example, the system can determine whether the result set includes a dimension across which aggregation can be performed. The system can determine whether a histogram is suitable for presenting the result set based on evaluating the result set against criteria for histogram generation. The criteria can include specified ranges for the number of data points, attributes, and/or metrics, number of attributes. Representing a large data set in a histogram format can provide the user with a concise, accurate representation of the distribution of the large data set in a way that conserves limited screen space, which is important on mobile devices and in small chatbot panes or windows shown alongside or as overlays on other documents (e.g., web pages, dashboards, reports, etc.).

The present techniques can use the AI/ML models to perform additional processing beyond the processing requested by the user, by generating additional processing instructions for the AI/ML models. The system can therefore generate chatbot responses that provide supplemental information to the user without the user specifically requesting the supplemental information. For example, when instructing an LLM to answer a user's question, the system can be configured to instruct the LLM to include certain characteristics, properties, statistics, or other features of the result data that answers the user's question. In some implementations, this can include requesting the LLM's answer to specify features such as the highest and lowest values of the result data generated based on the user's question.

The system can use a series of multiple interactions with an AI/ML model to generate answers to a user's question. For example, the system can provide an AI/ML model information about a data set (e.g., a data model for the data set, a data schema for the data set, metadata for the data set, sample data from the data set, etc.) and ask the AI/ML model to generate instructions or code that, when executed, would retrieve the subset of data from the data set that should be shown in a visualization. The system then examines the data retrieval instructions or code generated by the AI/ML model to translate those instructions into as set of characteristics that the visualization should have. For example, the system can use a program or set of rules to extract from the data retrieval instructions or code to a set of parameter values or features that define the visualization, e.g., a visualization type (e.g., line graph, bar chart, pie chart, heatmap, geographical map, etc.), data labels, assignment of values or data series to axes visualization regions, and so on. The system also uses the data retrieval instructions or code generated by the AI/ML model to retrieve data using the data processing system and the system uses the retrieved data to generate the visualization. As a result, the system can generate a visualization of data based on the ability of the AI/ML model to understand natural language understanding and infer relationships, along with the reliable and repeatable results from a data processing system such as a database management system.

As discussed further below, the present techniques show how visualizations and summaries of the result data shown in visualizations can be generated using the strengths of AI/ML models to interpret natural language and express relationships in a clear manner through data retrieval code or instructions. Rather than asking an AI/ML model to generate a visualization, the system can request that the AI/ML model generate code or instructions to retrieve the data that would be represented in the visualization. A separate, non-AI/ML module can extract the properties of the visualization, and the system can obtain the appropriate data and generate a visualization with the properties determined. The system can request that the AI/ML model generate a summary of the data presented in the visualization. The summary can include statistical information that was not specified in the original request or prompt. This technique can provide various advantages. For example, the AI/ML model is used for functions that it performs well (e.g., natural language interpretation, code generation), instead of for functions that are likely to give highly variable or inconsistent results (e.g., image generation). The AI/ML model can be used to generate an output using a standardized type of code, such as a structured query language (SQL) statement, Python code, etc., for which there is a large set of training data and existing AI/ML models with the output generation capability. In many cases, an existing model that is capable of generating SQL can be used, without the need to gather training data or expend the significant resources for training an AI/ML model to perform a customized task.

Using the AI/ML model to produce output in a standardized format such as SQL limits ambiguity and expresses relationships in a domain with clear rules and patterns, and much less variation than general text responses. In addition, asking the AI/ML model to specify the data to be obtained focuses the AI/ML model on the characteristics of the data set, and separates the visual design of the visualization. For example, the system is not dependent on the AI/ML model having been trained with appropriate examples of visualizations. The system, in translating from data retrieval code or instructions to visualization properties, can provide consistent styles, formatting, and visual characteristics across different user requests and data sets, which is often challenging for many AI/ML models. The use of a standardized format for the AI/ML model output also facilitates the use of different AI/ML models. Even if the particular AI/ML model is switched or updated, the system can still translate the code or instructions to visualization properties and also provide consistent visual characteristics and reliable accuracy for visualizations across many different AI/ML models.

In general, the system can support interactive applications where processing tasks for responding to a user prompt are split between non-AI/ML or non-probabilistic data processing systems (e.g., database management systems) and AI/ML models. For example, when a user prompt such as a natural language query is received, the computer system can use a database system to generate a set of result data that is relevant to the user prompt. The set of result data can then be processed using one or more AI/ML models, such as an LLM, to generate content to present in a response to the user. This system can combine the strengths of AI/ML models and non-AI/ML processing systems to provide responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. This may especially be the case when what is needed is an accurate representation of data from a particular data set that is not in the model's training data, and the data set is often larger than the model's context window. In some cases, AI/ML models provide content that includes hallucinations or content that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the system can provide visualizations as responses of chatbots and other interactive applications, in a way that combines the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data. The visualizations that are provided can be created with properties determined from AI/ML model output, but with the actual visual characteristics generated separate from the AI/ML model based on data retrieved from the source data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., a data model, data schema, metadata indicating a list of logical objects such as types of metrics and attributes, semantic meaning of the data columns, etc.). In some cases, sample data (e.g., a limited sampling of the data set, or fictitious examples that illustrate the type of content in the dataset without revealing the actual values and records) may be provided. In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers. With the system performing discrete operations leveraging AI/ML models, separate from the core querying of an enterprise's proprietary datasets, the chatbots can be more easily integrated with the processing capabilities of third-party systems.

In one general aspect, a method performed by one or more computers includes: receiving, by the one or more computers, a user prompt comprising text that includes a natural language statement from a user; obtaining, by the one or more computers, code or instructions generated by one or more artificial intelligence and/or machine learning (AI/ML) models to retrieve, from a data source, data specified by the natural language statement in the user prompt; translating, by the one or more computers, the code or instructions generated by the AI/ML model to data processing instructions for a database system; retrieving, by the one or more computers, the data from the database system based on the data processing instructions; generating, by the one or more computers, a request for the one or more AI/ML models to summarize the retrieved data; sending, by the one or more computers, the request to be processed by the one or more AI/ML models; receiving, by the one or more computers, a summary of the retrieved data that the one or more AI/ML models generated in response to the request; and providing, by the one or more computers, visualization data for display, wherein the visualization data is displayable to present the retrieved data from the data source and the summary of the retrieved data that the one or more AI/ML models generated.

In another general aspect, a method includes: receiving, by the one or more computers, a user prompt comprising text that includes a natural language statement from a user; obtaining, by the one or more computers, code or instructions generated by one or more artificial intelligence and/or machine learning (AI/ML) models to retrieve, from a data source, data specified by the natural language statement in the user prompt; retrieving, by the one or more computers, the data from the database system based on the code or instructions; sending, by the one or more computers, a request for the one or more AI/ML models to summarize the retrieved data, wherein the request includes (i) the user prompt and (ii) an additional instruction for information to include in the summary that is not requested in the user prompt; receiving, by the one or more computers, a summary of the retrieved data that the one or more AI/ML models generated in response to the request; and providing, by the one or more computers, a response to the user prompt that includes (i) visualization data for display, wherein the visualization data is displayable to describe the retrieved data from the data source and (ii) the summary of the retrieved data that the one or more AI/ML models generated.

In some implementations, the retrieved data comprises a data series; and the request for statistical information comprises a request for the one or more AI/ML models include in the summary an indication of a maximum value of the data series and a minimum value of the data series, wherein the user prompt does not request the maximum and minimum value to be provided.

In some implementations, the method includes providing a visualization that indicates amounts of items for each of multiple different intervals in a range of values, wherein the visualization is provided based on at least one of (i) analysis of the user prompt or (ii) analysis of the retrieved results.

In some implementations, the visualization is provided based on at least one of: a determination whether the retrieved data includes values for a dimension across which aggregation can be performed; and a determination that the retrieved data includes a number of data points, attributes, and/or metrics that is within a predetermined range.

In some implementations, the request for the one or more AI/ML models to summarize the retrieved data includes a request for statistical information related to the retrieved data, the summary of the retrieved data including the statistical information provided by the one or more AI/ML models in response to the request.

In some implementations, the method includes determining one or more visualization properties for the visualization data, wherein the retrieved data is presented according to the one or more visualization properties.

In some implementations, the method includes determining the one or more visualization properties for the visualization data based on the code or instructions generated by the one or more AI/ML models.

In some implementations, the method includes determining the one or more visualization properties for the visualization data based on the retrieved data from the database system.

In some implementations, the one or more visualization properties specify a visualization type, the visualization type comprising one of a bar graph, line graph, pie chart, heat map, geographical map, or histogram.

In some implementations, determining the one or more visualization properties includes evaluating the retrieved data using selection criteria for each of multiple visualization types, and selecting the visualization type from the multiple visualization types based on the evaluation of the retrieved data using the selection criteria.

In some implementations, the user prompt specifies a particular visualization type, and the method includes: determining that the retrieved data satisfies criteria for being represented by the particular visualization type; and in response, generating the visualization data to present the retrieved data in the particular visualization type.

In some implementations, the user prompt specifies a particular visualization type, and the method includes: determining that the retrieved data does not satisfy criteria for being represented by the particular visualization type; and in response, generating a message indicating that the retrieved data does not satisfy the criteria for being represented by the particular visualization type and generating the visualization data to present the retrieved data in a visualization type that is different from the particular visualization type.

In some implementations, the one or more visualization properties specify at least one of a visualization type, a label for a visualization or a portion of the visualization, a data series to be represented in the visualization, a layout of the visualization, or formatting of the visualization.

In some implementations, obtaining the code or instructions generated by the one or more AI/ML models includes: generating an initial request for the one or more AI/ML models to generate the code or instructions to retrieve, from the data source, the data specified by the natural language statement in the user prompt; sending the initial request to be processed by the one or more AI/ML models; and receiving the code or instructions generated by the one or more AI/ML models in response to the initial request.

In some implementations, the method includes selecting the data source based on a document or user interface that is active on a client device.

In some implementations, the method includes selecting the data source based on a window of a user interface that is selected on a client device.

In some implementations, the user prompt is input to a chatbot and the visualization data is provided as output of the chatbot in response to the user prompt.

In some implementations, the data source includes one or more data tables, and wherein the code or instructions specify one or more rows of data to retrieve and calculations using data from the one or more rows that generate values to be represented in the visualization data.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIGS. 1 and 2 are diagrams showing an example system for summarizing visualizations of data using artificial intelligence or machine learning.

FIGS. 3 to 7 show example user interfaces showing functionality for providing visualizations and summaries of result data generated using artificial intelligence or machine learning.

Like reference numbers and designations in the various drawings indicate like elements.

### DETAILED DESCRIPTION

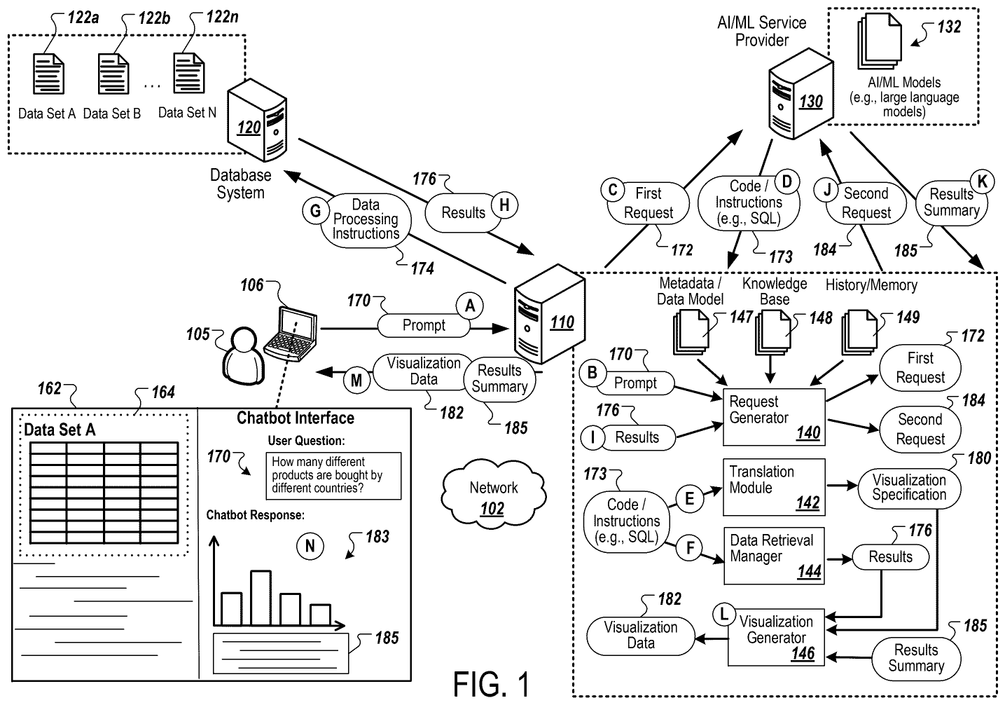

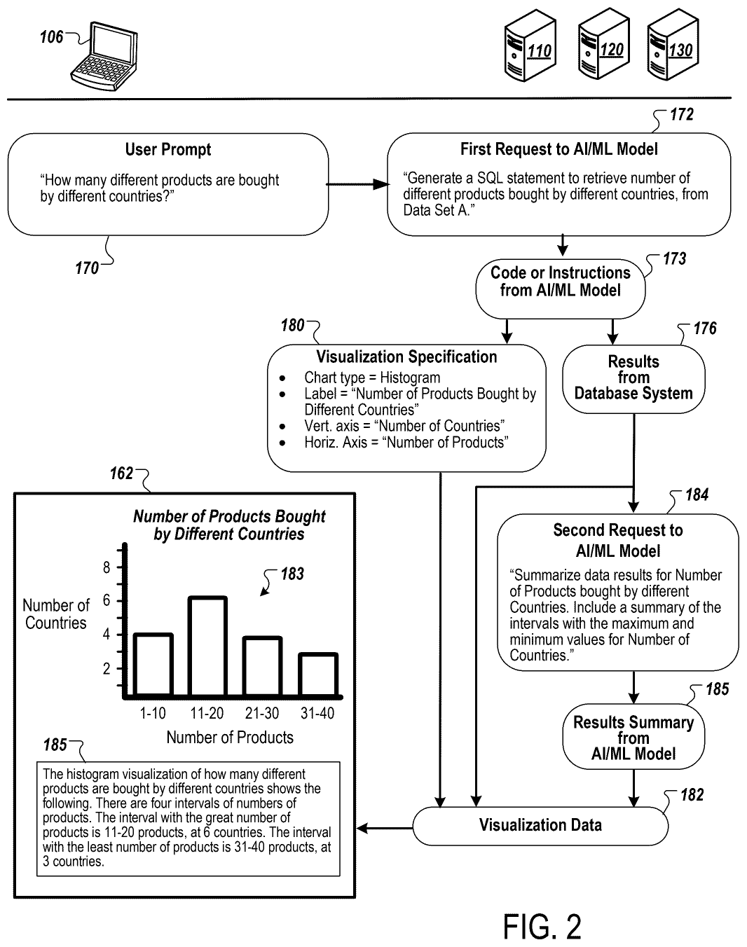

FIGS. 1 and 2 are diagrams showing an example system 100 for summarizing and visualizing result data using artificial intelligence or machine learning. The system 100 includes a computer system 110, a database system 120, and an AI/ML service provider 130. The elements of the system 100 communicate over a network 102, such as the Internet. The computer system 110 coordinates a variety of operations to provide and manage access to chatbots and other AI/ML applications that can provide data visualizations. In the example, a user 105 interacts with a user interface 162 using a user device 106. In response to user interaction, the computer system 110 obtains data from the AI/ML service provider 130 and the database system 120 to obtain information used to generate a visualization 183 and a summary 185 of the visualization 183 presented on the user interface 162. The example of FIG. 1 includes stages (A) to (N), which represent various operations and a flow of data, and which can occur in the order illustrated or in a different order.

The computer system 110 can be implemented using one or more servers, such as one or more cloud computing systems, one or more on-premises servers, etc. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

Different users have access to different datasets 122a-122n and chatbots, depending on their roles, permissions, etc. The user 105 authenticates, so that the user's identity is determined and the user's permissions can be determined. Based on the user's identity, permissions, and access control data (e.g., access control lists specifying authorized users), the computer system 110 manages access of the user to chatbots and other AI/ML applications.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

As an overview, in the example of FIG. 1, a user 105 interacts with a chatbot through a user interface 162, and the computer system 110 manages a process of generating and providing a visualization and a summary of the visualization to the user 105. For example, after the user 105 enters a user prompt 170 and the user's device 106 sends the prompt 170 to the computer system 110 for processing. The computer system 110 receives the prompt 170 and begins a series of interactions used to generate a visualization and summary based on the prompt 170. The process of generating the visualization and summary includes the computer system 110 requesting that an AI/ML model 132 generate code or instructions for retrieving, from a particular data set 122a, data to be represented in the visualization to be generated. Once the AI/ML model 132 provides the requested code or instructions 173, the computer system 110 extracts information from the code or instructions 173 to determine properties of the visualization that are shown as a visualization specification 180. The computer system 110 also converts the code or instructions 173 into a set of data processing instructions 174 that the database system 120 uses to retrieve the data to be shown in the visualization. The computer system 110 requests that the AI/ML model 132 generate a summary of results 176 from the database system 120. The computer system 110 uses the visualization specification 180, the results 176 from the database system 120, and a results summary 185 generated by the AI/ML model 132 to generate visualization data 182 that is sent to the user device 106 for display.

In further detail, in stage (A), the user 105 enters a prompt 170 in a user interface 162 as input to a chatbot, and the prompt 170 is sent to the computer system 110 over the network 102. The user device 106 of the user 105 displays a user interface 162 that shows information about data set 122a, labeled “Data Set A.” For example, the user interface 162 may show a document, dashboard, file manager, or other type of user interface content. The user interface 162 includes a region, such as a panel on the side, for the user 105 to have a conversation with a chatbot. The chatbot interface, like the rest of the user interface 162, can be a web page, a web application, a native application, or other functionality.

In the example, the user 105 entered “How many different products are bought by different countries?” as the prompt 170. The user device 106 and/or the computer system 110 can determine which data set to use in generating the visualization in any of various ways. For example, the chatbot may be a chatbot that has been created to or designated to be used for answering questions about the particular data set 122a, so the chatbot is pre-configured to use the data set 122a.

As another example, the computer system 110 and/or the chatbot may receive context information about whichever data set 122a-122n is currently active and relevant to the user interface 162. For example, the data set 122a can be identified based on being referenced in the user interface 162, for being referenced in content or metadata for a document shown in the user interface 162, for being the source of data shown in another visualization in the user interface 162, for being used to generate content shown in the user interface 162, and so on.

As another example, the data set 122a can be identified based on being selected by the user in the user interface 162. For example, the user 105 may select a window or portion of a window showing information from the data set 122a, and as a result the window can be highlighted or emphasized, such as by an outline 164 being presented in the user interface 162. The selection of the window may establish that the data set 122a is the data set relevant to the conversion.

As another example, the user prompt 170 may be provided as part of a longer conversation with the chatbot, and previous interactions with the chatbot (e.g., conversation history, for the current session or previous sessions) may establish that the data set 122a is the data set relevant to the conversation.

Other options are also possible. For example, the computer system 110 or the chatbot can search among data sets that the user 105 is authorized to access and determine which data set(s) are most relevant to terms of the prompt 170, such as “products.” Similarly, the computer system 110 may store usage data for the user 105 that indicates which data sets 122a-122n are most frequently or most recently accessed by the user 105 in any of various ways (e.g., the user reading, writing, editing, sharing, querying, interacting with chatbots, etc.), and the computer system 110 can select which data set is most likely based on the usage data.

In stage (B), the computer system 110 generates a first request 172 to the AI/ML service provider 130, requesting for an AI/ML model 132 to generate code or instructions for retrieving the data to be shown in a data visualization. In the example, the computer system 110 does not request for the AI/ML model 132 to provide the values to be depicted in the visualization or even for the AI/ML model 132 to describe the visualization. Instead, the first request 172 asks for code or instructions that, when executed, would retrieve and/or calculate the data that would be shown in the visualization. For example, the first request 172 asks for the AI/ML model 132 to provide instructions in a standardized format, such as a SQL statement, that specifies a portion of the data set 122a to be retrieved and/or operations to calculate values from that data. As discussed below, the computer system 110 will later determine the visual properties of the visualization and obtain the data to be represented, without the AI/ML model 132 needing to provide that data or describe the visualization.

The computer system 110 is illustrated to include a request generator 140, for example, a software module that generates the first request 172 based on the prompt 170. The natural language text of the user prompt 170 can provide one or more criteria for the particular subset of data or particular values to be retrieved and ultimately illustrated in the visualization to be generated. Generating the first request 172 can include generating modified text as a prompt to the AI/ML model 132, such as an LLM. For example, the text of the user prompt 170 can be supplemented and/or edited in various ways, such as to specify that data retrieval is desired for the topic of the user prompt 170, to specify a format or programming language for the output of the AI/ML model 132 (e.g., SQL, Python, etc.), to specify which data set 122a-122n data will be retrieved from, and so on. For example, referring to FIG. 2, for the user prompt 170 “How many different products are bought by different countries?,” the request generator 140 can create the modified prompt “Generate a SQL statement to retrieve number of different products by country, from Data Set A.” The request generator 140 or other functionality of the computer system 110 can store rules, examples, or other data that specify keywords, phrases, patterns, or other text content that represents a request for a visualization, and the request generator 140 can insert a data retrieval instruction in its place.

As another example, the request generator 140 may generate an instruction to the AI/ML model 132 that includes the entire user prompt 170 unaltered, but adds additional instruction before and/or after, such as “Generate a SQL statement to retrieve data from Data Set A that would be shown in a visualization responding to the prompt ‘How many different products are bought by different countries?” Many different text formats and options can be used by the request generator 140. In some implementations, the text in the first request 172 can be tailored for the particular AI/ML model 132 to be interacted with, so that different request text would be generated for requests to different AI/ML models 132 (e.g., models from different sources, models with different capabilities, etc.).

The request generator 140 also generates the first request 172 to include additional information to assist the AI/ML model in responding to the first request 172, such as metadata or a data model 147 for the data set 122a, a knowledge base 148, and/or history or memory 149 for the chatbot. Each of these types of additional information can be provided in or with the first request 172 as context that the AI/ML model 132 can use to generate data retrieval code or instructions accurately.

The data model 147 can include information about the data set(s) that the chatbot will use to respond to the first request 172, without including actual data from the data set. For example, the data model 147 can include a data schema for the data set 122a. In general, the data model 147 can indicate a list of logical objects represented in the data set 122a, such as a list of the elements or components of the data set. For example, the data model 147 can indicate that the data set 122a includes logical objects such as date, customer identifier, country code, product name, and so on. These data objects can represent quantities or data objects that are represented in, or can be derived from, data in the data set 122a. The logical objects, such as metrics or attributes, can represent the type of data that is stored in or derived from a column of data. For example, an attribute may represent a type of data stored in a column of a data table or the result that would be obtained by applying a particular arithmetic expression to data in a column. Similarly, a metric or fact can represent the result of applying a particular aggregation function or other operation(s) to values in one or more columns of a data table. Accordingly, the data model 147 can indicate the attributes and metrics that are available for the AI/ML model 132 to work with, and potentially additional attributes or metrics that can be generated or operations that are available for the database system 120 to create a new attributes or metrics.

In some cases, the data model 147 can indicate, through the logical objects identified, types of data from tables, columns, and other elements that make up the data set 122a, in addition to or instead of the semantic meanings and/or relationships among these elements of the data set 122a. For example, the data model 147 can indicate that the data set 122a includes set of data named “product_table,” that includes an attribute named “product_name” that indicates names of products and another attribute named “country” that indicates the country from which the product was purchased. These quantities may or may not correspond directly to the structure of the data set 122a. For example, the item “product_table” may be an actual data table of a database, or may not represent a table and instead another grouping of data. Similarly, the “product_name” and “country” objects may correspond to specific columns of a data table, but may alternatively represent values that can be calculated or otherwise derived from the data set 122a in another way. Providing the data model 147 can give the AI/ML model 132 a list and description of the logical objects that the database system 120 recognizes. As a result, the AI/ML model 132 can generate code or instructions that reference these logical objects that are understood by the computer system 110 and the database system 120. To the extent that the objects indicated in the data model 147 differ from the actual structure of the data set 122a, the computer system 110 and the database system 120 can use convert from the logical object names used in the data model 147 to actual data set elements and functions.

The data model 147 can indicate the names or labels for these data elements, classifications of the elements (e.g., metric, attribute, etc.), and other information. In some implementations, the data model 147 can include sample data for the data set 122a, such as a sampling of data from the data set 122a. The sample data can be fictitious example data that may be artificially synthesized to be representative of the data in the data set 122a (e.g., similar types of data), without indicating actual contents of the data set 122a. The data model 147 can be provided in any of various forms, such as a database schema from a database management system, a list or definitions of objects, components, or identifiers of the data set 122a, etc.

By providing the data model 147 with the first request 172, the computer system 110 provides the AI/ML model 132 the ability to make use of the logical objects specified in the data model 147. As a result, the AI/ML model 132 can determine the types of data that would be available from the data set 122a, even without the AI/ML model 132 having any access to the data set 122a. The AI/ML model 132 can generate code or instructions (e.g., a SQL statement) that references these logical objects, with a clear set of names or other identifiers to accurately and unambiguously reference components of the data set 122a. For example, providing the data model 147 for the data set 122a, may enable the AI/ML model 132 to reference logical objects in generated SQL statements that the computer system 110 and/or database system 120 can unambiguously map the logical objects to tables and columns of the data set 122a. This allows the AI/ML model 132 to distinctly and unambiguously define criteria to specify the subset or portion of data to be retrieved from, or calculated based on, the data set 122a.

In addition, access control restrictions can be taken into account to adjust which data can be used. For example, the computer system 110 can generate the first request 172 so that the AI/ML model 132 does not use or rely on portions of the data set 122a that the user 105 does not have authorization to access. For example, the data model 147 provided with the first request 172 can be a modified version of the data model for the data set 122a that identifies only the logical objects or portions of the data set 122a that the user 105 is authorized to access, and excludes portions of the data set 122a that the user 105 is not authorized to access. As a result, the AI/ML model 132 will not be aware of data sets or data objects that should not be accessed on behalf of the user 105.

The knowledge base 148 can provide a mapping for the AI/ML model 132 to map words and phrases with non-standard or idiosyncratic meanings (e.g., jargon, nicknames, etc.) to definitions, descriptions, or other indications of their meaning. The knowledge base 148 can include information determined at any of multiple levels, such as at the level of an enterprise as a whole, for a department or group of individuals, or for a specific individual. Similarly, the knowledge base 148 can be one that has been created for a single chatbot or AI/ML application or one that is shared with multiple chatbots or AI/ML applications.

In some implementations, the computer system 110 enables the administrator 103 to attach one or more additional data sets to adjust the operation and output of the chatbot. For example, an additional data set can be a knowledge base 148 or data dictionary can be added. Unlike the primary data set that the user selects for the chatbot (e.g., data set 122a), the chatbot is not configured to answer questions about the additional data set or to retrieve metrics or to provide visualizations of the knowledge base 148. Instead, the knowledge base 148 can be provided to assist the chatbot in interpreting user queries and providing responses with the terminology for the user's organization. In general, the knowledge base 148 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 148 is designated for the chatbot to describe these and other internal terms. Each time the user submits a prompt, the knowledge base 148 can be provided to assist the LLM with the context that is appropriate for the company. The knowledge base 148 can provide information similar to a semantic graph, by describing entities and their relationships. In some cases, the information in the knowledge base 148 can be derived from a semantic graph 150 and then converted into text (e.g., unstructured, semi-structured, or structured) in a format that can be processed by the LLM.

In general, the knowledge base 148 or other additional data set can include data that maps terms or phrases to their meanings. In many cases, this can include semi-structured data or explanatory content, as a way to explain entities and relationships wo the AI/ML models 132. Although the knowledge base 148 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 148 as contextual data sets that can be applied consistently across the enterprise, for all chatbots created and used in the enterprise. Similarly, different departments within the enterprise may add their own particular contextual data sets that may supplement the enterprise-wide knowledge bases 148. In addition, specific contextual data sets can be added for specific chatbots. In this way, chatbots at different levels of an organization can inherit a consistent set of terminology and knowledge in an organization, which also makes maintaining the overall knowledge base much simpler. The knowledge base 148 can additionally or alternatively be specified with a scope that corresponds to a computing environment, so that chatbots associated with a particular domain or server inherit the knowledge bases for that domain or server.

One of the advantages of the knowledge base 148 is consistency for many users and even for many different chatbots of an organization. The user submitting a prompt does not need to take any action to select or include the knowledge base 148 in the chatbot's processing, the chatbot automatically include the knowledge base 148 in its context for each prompt or question received. Also, because the knowledge base 148 can be shared or inherited by many chatbots within an organization, updating and maintaining the knowledge base 148 is simple. An edit to the knowledge base 148 is automatically applied to all of the chatbots associated with the organization, even if the chatbots were created by different administrators or provided to different sets of users.

In addition, the knowledge base 148 provides persistent context that is not lost from one prompt to another or from one session to another. The knowledge base content can also be implemented applied in a manner that the knowledge base 148 does not count toward the instruction token limits that the AI/ML models 132 consume for each response. Rather than counting toward the tokens for prompts and recent history, the knowledge base 148 can be accessed or provided to the AI/ML models 132 as a separate source of knowledge apart from the prompt and context, and so does not count toward the token limits of an LLM. Implementations of access to the knowledge base 148 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 148 can be prepared as an embedding, a vector database, or other format that can be accessed by or referred to by the AI/ML models 132.

The history or memory 149 can represent any of various types of information that can be stored external to the AI/ML models 132 but captures information about previous sessions, previous conversations or previous text of the current conversation, preferences of one or more users, learning from feedback of one or more users, and so on. In some implementations, the chatbot is designed to have a long-term memory 149, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 149 for the chatbot. For example, the long-term memory 149 can store items such as definitions of terms for a particular user context, unique text elements the chatbot might encounter, and feedback from prior user interactions.

One valuable aspect of the long-term memory 149 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

The learning of the chatbot is managed by the computer system 110 and happens on an ongoing basis as users interact with the chatbot. The information learned is stored outside the LLM or other AI/ML models 132, and is stored in the long-term memory 149 designated for the chatbot. Each chatbot that is created can have its own long-term memory 149, which is updated by the interactions of its own users. Before the computer system 110 asks the stateless LLM to provide a response to a user prompt, the computer system 110 facilitates retrieval of data from the long-term memory 149, potentially to provide customized instructions or additional contextual data to accompany the user prompt and tailor the response based on what has been learned from prior interactions. The long-term memory 149 thus provides better reference data for LLM to use in guiding answer generation.

The long-term memory 149 can include business definitions of other users have specified or uploaded. In this way, the long-term memory 149 can supplement or expand on the descriptions provided in the knowledge base 148. The information can be stored and used at different levels, e.g., at the level of individual users, at the level of a department or group of users, and for an enterprise as a whole. In other words, the preferences of an individual may be learned and applied for that individual. In addition, the aggregate preferences learned for many individuals can be combined to also adjust the chatbot, to accelerate the adaptation of the chatbot to meet the needs of the user base. In some implementations, the computer system 110 can use access control lists and permissions for users to apply security policies to adjust access and appropriately set the context for each user.

In some implementations, given the user interactions or feedback received through prompt-response cycles with the user 105c and/or other users, the long-term memory 149 may include information that can clarify what users intend when they ask a question as indicated in the prompt 170. For example, the long-term memory may specify that a visualization should be included, or that data should be ordered in a particular way. In addition, the computer system 110 also stores information about the user 105c and his current context, represented as user context data 156. This user context data 156 can indicate, for example, the identity of the user, permissions of the user, a device type of the user's device 106, a location of the user, a role of the user, a department of the user, and so on. In addition, the computer system 110 stores conversation histories 157 of users that have previously interacted with the chatbot. As a result, information about previous prompts from the user 105c and previous responses, in whole or in part (e.g., in summary form) and from the current session and/or previous sessions, can be retrieved and used to supplement the prompt 170. The computer system 110 can provide the user context data 156 and conversation history 157 for the user 105 in or with the first request 172, so the AI/ML model 132 can generate data processing instructions with the context of the user's situation and previous conversations, which may better explain or help disambiguate the most recent prompt 170.

In stage (C), the computer system 110 sends the first request 172 to the AI/ML service provider 130. As discussed above, the first request 172 can include an instruction for the AI/ML model 132 to generate code or instructions (e.g., SQL) that would retrieve, from the data set 122a, data to be represented in a visualization according to the prompt 170. For example, the first request 172 specifies the data set 122a to use and the criteria (e.g., from the user prompt 170) for which data should be retrieved from the data set 122a. The first request 172 also includes information about the dataset 122a, such as the data model 147, which can describe the structure and content of the data set, including items such as the names, semantic meaning, and relationships of components of the data set 122a.

As a result, the first request 172 can be a request for a SQL statement or Python code that, when interpreted or executed by another system such as the database system 120, will cause the other system to retrieve and/or generate a focused subset of data (e.g., a result data set) from the data set 122a that would be shown in a visualization as requested by the user prompt 170. By requesting code or instructions, the process takes advantage of the ability of AI/ML models 132 to reliably produce high-quality code or instructions expressed in programming languages (e.g., SQL, Python, Java, HTML, XML, etc.). This often generates in a more concise and unambiguous result than more free-form text outputs. This type of request guides or constrains the AI/ML model 132 to follow the conventions of a particular programming language (which can be specified in the first request 172). Programming languages are usually designed to avoid ambiguity and to promote consistency in usage of terms across many different situations. As a result, code examples often demonstrate clear usage patterns that the AI/ML models 132 can learn from and follow.

Also, by requesting that the AI/ML model 132 create the code or instructions using a standardized format, such as SQL, this greatly increases the number of different AI/ML models 132 that can be used with the system. For examples, many different LLMs may have a capability to create SQL, while models, if any, may be able to reliably generate visualizations or descriptions of visualizations. With many different options for selecting an AI/ML model 132 to create SQL, the computer system 110 has the versatility to vary which AI/ML service provider or model is used (e.g., for cost, speed, load balancing, etc.) and the robustness to change which model is used if a AI/ML service provider or model becomes unavailable.

Requesting that the AI/ML model 132 create code or instructions for data retrieval takes advantage of strengths of LLMs, such as natural language interpretation of the user's prompt 170 and ability to generate text, such as code, that follows established patterns or rules. This also constrains the constrains the form of the output to a set of code or instructions, such as SQL or another standardized representation, which allows the high-quality results to be achieved reliably.

In stage (D), the AI/ML service provider 130 uses one or more of the AI/ML models 132 to generate a response to the first request 172. The AI/ML service provider 130 then sends the response, code or instructions 173 for retrieving or processing data, to the computer system 110. For example, the AI/ML service provider 130 uses the AI/ML models 132 to generate, as the code or instructions 173, a SQL statement that, when executed by the database system 120, will retrieve and/or generate the data needed to answer the prompt 170 based on the data set 122a. The code or instructions 173 can be expressed in any of a variety of ways, such as one or more SQL statements, as executable or interpretable code, such as Python code, as a list of API calls or commands to be executed, and so on. The code or instructions 173 can provide instructions for retrieving specific portions of one or more data sets, such as from the specific data set 122a specified in the prompt 170 or otherwise indicated to the AI/ML model 132 used. The code or instructions 173 can additionally or alternatively instruct various data processing steps or operations to be performed, including data joins, data aggregations, filtering data, evaluating expressions, creating new metrics and calculating their values, etc.

Although the computer system 110 is ultimately generating a visualization for the user 105, the computer system 110 did not request or receive a visualization or a description of a visualization from the AI/ML model 132. Instead, the computer system 110 uses the AI/ML model 132 to generate the code or instructions 173 for data retrieval (e.g., retrieving “product_name” values from the “product_table” table, by country) and data processing (e.g., calculating a number of different products bought by different countries) to generate product values for the countries. The computer system 110 can then coordinate the actual retrieval and processing of the data using the database system 120 to obtain reliable, accurate values to be shown, without the risk of an AI/ML model losing precision or hallucinating incorrect values. The computer system 110 can also select the appropriate visualization type and visualization properties in a way that produces consistent results, conforms to a visual theme or style, without the probabilistic variations of many AI/ML models.

One advantage of the approach of using the AI/ML models 132 to generate code or instructions 173 is that the AI/ML models 132 can be used for generating visualizations without the need to train the AI/ML models 132 for the function of creating or designing visualizations. Instead, the AI/ML models 132 can learn to provide code or instructions, which is more commonly available and is a more objectively-defined task than generating a visualization, which often has more subjective and aesthetic qualities that may result in inconsistent result. There are also typically many good examples of SQL statements and other code that provide good patterns for an AI/ML model to learn. Obtaining a large number of high-quality examples of data visualizations is more difficult and would often require a large quantity of specialized training data. In addition, unlike examples of code, examples of visualizations would not necessarily provide consistent patterns that would allow a model to reliably learn meaningful representations of data.

In stage (E), the computer system 110 examines the code or instructions 173 from the AI/ML model 132 to determine characteristics of the visualization to be created. For example, a translation module 142 can examine the code or instructions 173 to identify data objects, relationships, and other aspects that can be mapped to features of a visualization. The translation module 142 can specify the characteristics of the visualization, as extracted from or inferred based on the code or instructions 173, in a visualization specification 180, which can indicate any of various features to be shown (e.g., data objects to be retrieved or calculated, visualization type, which data series to be illustrated, independent or dependent variables, data ranges, labels for visualization components, and so on).

In some implementations, the visualization specification 180 includes sufficient information for a data processing system, such as the database system 120, to retrieve and calculate all of the data needed to create a visualization or to refresh the visualization with updated information from the data set 122a. In some cases this includes indicating when new logical objects or new quantities need to be defined. For example, if a visualization would use a new column of data that is not natively stored in the data set 122a but is calculated based on columns of data in the data set 122a, the visualization specification 180 can define this column and specify the operations or expressions used to calculated it. For example, if a visualization involves a “profit” metric not stored in the data set 122a, the visualization specification 180 can define the “profit” value to be a “sales” value minus a “cost” value, where the “sales” and “cost” are values (e.g., attributes or metrics) that are part of the data set 122a. As a result, using the visualization specification 180, the database system 120 would be able to identify the types of data that need to be retrieved and/or calculated and generate those values for the visualization.

For example, the translation module 142 can examine the SQL statement that the AI/ML model 132 provided as the code or instructions 173 to identify data that is retrieved or calculated. The significance of the different types of data referenced can be inferred from the clauses, commands, or operators used in the code or instructions 173. Based on the information extracted from the code or instructions 173, and the data model 147 describing the semantic meanings, data types, and/or relationships of these data objects in the data set 122a, the translation module 142 can select a visualization type, e.g., line graph, bar chart, pie chart, heat map, geographical map, etc. The selection can be based on any of multiple factors, including the number of attributes and metrics referred to (e.g., where some visualization types are better suited for larger numbers of data objects), the number of data series (e.g., line charts can show multiple data series, while a pie chart is better suited for a single group of values), relationships of the data objects (e.g., with line charts and bar charts showing relationships with respect to time better than geographical maps, which show relationships with respect to locations), the semantic meanings of the data objects (e.g., a geographical map being more likely when a city, state, country, or other geographical independent variable is present), and so on.

In this case, the translation module 142 selects a histogram as an appropriate visualization type. Other types of visualizations could similarly be selected (e.g., bar chart, geographic map, pie chart, table, bubble chart etc.) A histogram is a visual representation of the distribution of quantitative data. To construct a histogram, the first step is to “bin” (or “bucket”) the range of values by dividing the entire range of values into a series of intervals, and then count how many values fall into each interval. The bins can be specified as consecutive, non-overlapping intervals of a variable.

The visualization specification 180 includes the various characteristics, parameter values, and relationships determined from analysis of the code or instructions 173, and determined from analysis of the results 176. For example, referring to FIG. 2, the visualization specification 180 can indicate a histogram as the type of visualization, the number of countries as the quantity defining the height of each bar of the histogram, “Number of Countries” as a label for the y-axis, and “Number of Products” as labels for the x-axis, and so on. In some cases, the visualization specification 180 can indicate a number of intervals and/or a size of intervals for a histogram. For example, the results 176 may indicate that a maximum number of products purchased by any country is 38, and a minimum number of products purchased by any country is 2. Therefore, the visualization specification can indicate four different intervals each having a range of ten values, or eight different intervals each having a range of five values, such that the x-axis covers a range up to a maximum value of 40 which is greater than the largest number of products purchased by any country. Many of these features of the visualization specification (e.g., the number of intervals, the boundaries of the intervals, the overall range of the histogram) will depend on the values in the data retrieved from the data set, and so these properties or parameters can be set after the results from the database system 120 are retrieved.

The visualization specification 180 can also specify other properties that may be selected based on factors or sources other than the content of the code or instructions 173. For example, the computer system 110 can store templates that specify visual properties for layout, formatting, font, size, color, and so on. The style template or visual style used can be selected based on user preferences, a selection for the company or other organization, a style of the current document or project in the user interface 162, a default style, and so on. These visual properties can be included in the visualization specification 180 or the visualization specification 180 can include an identifier or reference (e.g., URL) to a source of style information (e.g., a style template document, a cascading style sheet, etc.).

The computer 110 can select an appropriate type of visualization based on the user prompt and the results 176. In some examples, the user prompt 170 indicates a visualization type. The computer system 110 can determine whether the requested visualization type is appropriate for the prompt 170. For example, the computer system 110 can evaluate the prompt 170, the results 176, or both, using criteria for visualization types. The criteria can include, for a particular visualization type, a dimension of values, a maximum number of attributes, a minimum number of attributes, a maximum number of attributes per metric value, a minimum number of attributes per metric value, a maximum range of values, a minimum range of values, and other criteria.

In some examples, the prompt 170 may indicate a requested visualization type, and the computer system 110 may determine that the requested visualization type is not suitable for displaying the results 176. The computer system 110 can output, for presentation on the user interface 162, a message stating that the requested type of visualization is not recommended for the requested data. The computer system 110 can select and generate a different type of visualization and can provide a visualization of that type to the user device 106.

In stage (F), the computer system 110 coordinates the retrieval of data from the data set 122a that will be shown in the visualization. The computer system 110 uses the code or instructions 173 generated by the AI/ML model 132 in this process and obtains the data from the data set 122a from the database system 120. In some implementations, the computer system 110 uses a data retrieval manager 144 module to examine the code or instructions 173, such as to verify or edit the code or instructions 173 as needed for compatibility or efficient processing by the database system 120. In some cases, the standardized format of the code or instructions 173 allows it to be provided directly to the database system 120 for execution or processing. In other cases, the data retrieval manager 144 may alter the code or instructions 173 or translate the code or instructions 173 to another form. For example, the data retrieval manager 144 can translate a generalized or standardized set of code, such as a SQL statement, into a more specialized or targeted form of data processing instructions 174 that makes use of the specific features of the database system 120. For example, the generated data processing instructions 174 can reference functions, commands, modules, application programming interfaces (APIs), or other features of that database system 120 that may go beyond or may not be supported in the more standardized code or instructions 173.

As another example, although the AI/ML model 132 has the data model 147 for the data set 122a in its context when processing the first request 172, the resulting code or instructions 173 may include errors, such as incorrect identifiers for attributes, metrics, data sources, or other references to the data set 122a. Similarly, although the AI/ML model 132 may have a very strong capability for generating SQL content, there may still occasionally be errors in the code or instructions 173. The data retrieval manager 144 can examine and validate the code or instructions 173 to identify and correct errors in the syntax or structure of the SQL statement or other content present, and similarly update references to the data set 122a to generate a set of data processing instructions 174 that can be executed correctly by the database system 120. For example, the computer system 110 may apply a set of rules or validation checks to verify that the code or instructions 173 are valid and appropriate to be executed by the database system 120. For example, the computer system 110 can store rules or heuristics 152 that can evaluate the data processing instructions 174 element by element and/or as a whole to verify and correct the code or instructions 173 if needed before they are sent to the database system 120. In some implementations, the computer system 110 uses the rules or heuristics 152 to convert or transform the code or instructions 173 from one format or type to another.

The computer system 110 and the database system 120 can apply access control policies or customize operation based on the identity or role of the user 105 issuing the prompt 170. As a result, the data processing instructions 174 and other operations performed, and the data used, can be limited to what the user 105 is authorized to access. The computer system 110 can examine the code or instructions 173 to apply access control policies, to ensure that no data that the user 105 is not authorized to access is used. If unauthorized data is referenced, the computer system 110 can modify the code or instructions 173 to remove use of unauthorized data or to replace those references with an authorized set of data. The database system 120 similarly applies access control policies when processing the data processing instructions 174.

In stage (G), the computer system 110 sends the data processing instructions 174 to the database system 120, to instruct the database system 120 to retrieve the data needed to be shown in the visualization. As discussed above, the data processing instructions 174 can include the code or instructions 173, or can include a modified version of the code or instructions 173, such as a version that has been converted or translated to a different form for processing by the database system 120.

In stage (H), the database system 120 retrieves and/or calculates a set of results 176 based on the data processing instructions 174 and sends those results 176 to the computer system 110. For example, in the example of FIG. 1, the results 176 include the values of “Number of Products” calculated for each of the countries in the table “product_table” of the data set 122a.

In stage (I), the computer system 110 generates a second request 184 to the AI/ML service provider 130, requesting for an AI/ML model 132 to generate a summary of the results 176. The second request 184 can include the results 176 and can include a request for a results summary 185. For example, referring to FIG. 2, the second request 184 includes a prompt stating “Summarize data results for Number of Products bought by different Countries. Include a summary of the intervals with the maximum and minimum values for Number of Countries.” The second request 184 can include a request for information specified by the prompt 170. For example, the prompt may state “provide mean and median values for the number of products bought by countries,” and the system can therefore include a request for the mean and median values in the second request 184.

In some implementations, the computer system 110 provides the user's prompt 170 and asks the AI/ML model 132 to answer the user's prompt using the results 176. For example, the second request 184 may include a prompt such as “Answer the prompt ‘How many different products are bought by different countries?’ using the following data,” and the results 176 are provided. In this case, the prompt in the second request 184 can still include an instruction such as “include the maximum value and minimum value” for one or more of the data objects in the results 176. Even though the user may not have requested the maximum or minimum values, the computer system 110 can specify for the AI/ML model 132 to supplement the requested information with these or other statistical measures to enhance the information provided to the user.

In stage (J), the computer system 110 sends the second request 184 to the AI/ML service provider 130. In some examples, the second request 184 has a standardized format, such that the results summary 185 generated for multiple different prompts are also standardized. For example, a standardized second request 184 can include a request for statistical information (e.g., mean, median, mode, maximum, minimum, standard deviation, variance), even when those values are not specified in the prompt 170, so that the standardized results summary 185 includes the statistical information.

In stage (K), the AI/ML service provider 130 uses one or more of the AI/ML models 132 to generate a response to the second request 184. The AI/ML service provider 130 then sends the response, the results summary 185, to the computer system 110. For example, the AI/ML service provider 130 uses the AI/ML models 132 to generate a summary of the results 176 and to provide information as specified by the second request 184.

In stage (L), the computer system 110 combines the retrieved data in the results 176 from the database system 120 with the results summary 185 received from the AI/ML service provider 130 and the visualization characteristics specified in the visualization specification 180 to generate visualization data 182 that can be rendered or displayed by the user device 106. The computer system 110 can use a visualization generator 146 module to create the visualization data 182, such as image data, markup language content (e.g., HTML, XML, etc.), or other data that can be rendered or displayed to provide the visualization. For example, from the results 176, the visualization generator 146 can obtain values for the number of products for multiple different countries. Based on the visualization specifications 180, the visualization generator 146 determines that the values should be indicated in a histogram, and the visualization generator 146 generates the histogram with layout, style, formatting, and other properties as specified in the visualization specifications 180.

The computer system 110 can store and use predetermined criteria for determining when a histogram is appropriate, so the histogram can be selectively used based on the user prompt 170 and/or the results 176. For example, the computer system 110 can store a set of terms such as “histogram,” “distribution,” etc. that, when present in a user prompt 170, will cause the computer system 110 to detect that a histogram is being requested. In addition, or as an alternative, the computer system 110 can store criteria indicating that a histogram is appropriate when the number of result values is in a particular range, e.g., greater than a minimum threshold (e.g., 3, 5, 10, etc. values) and less than a maximum threshold (e.g., 1,000, 10,000, etc. values). In addition, or as an alternative, the computer system 110 can store criteria indicating that a histogram is appropriate when the results 176 have values or information for a particular types of data objects, such as at least one metric, or at least one metric aggregated by an attribute, etc. Using these stored criteria, the computer system 110 can recognize when a user requests a histogram to be provided and when the result data (e.g., results 176 from the database system 120) has the needed characteristics to generate a histogram. The computer system 110 can also determine to provide a histogram even when the user does not ask for it or include corresponding keywords in the user prompt, and the computer system 110 instead determines that the characteristics of the results 176 satisfy characteristics for showing a histogram.

As noted above, even if the visualization specification indicates that a histogram should be generated, various parameters of the histogram can be determined based on the values in the results 176. For example, the range spanned by the intervals of the histogram can be determined based on the maximum and minimum values of the object represented in the histogram. The number of intervals can be selected based on the number of data points or data values in the results 176, and the size of intervals for the histogram can be selected based on the number of data points or data values in the results 176 also.

In some implementations, the computer system 110 can use these criteria to detect when a histogram is appropriate for a set of result data and/or the types of data objects a user has requested information about, and the computer system 110 can cause a histogram to be generated even if the user does not request it. For example, if the number of data values returned that answer a user's prompt 170 is large, or the distribution has certain characteristics (e.g., is determined by the computer system 110 to have a curve, clustering pattern, or other relationship), then the computer system 110 can generate and provide a histogram visualization of the results 176, even if the user's prompt 170 does not request it. The histogram may be provided along with another visualization (e.g., chart, table, graph, etc.) that the user requested, or as the primary response to the user's prompt 170.

In stage (M), the computer system 110 sends the visualization data 182 and the results summary 185 to the user device 106 over the network 102, as a response to the user prompt 170.

In stage (N), the user device 106 receives and processes the visualization data 182, and displays a visualization 183 as a rendering of the visualization data 182. As a result, the user interface 162 is updated to show the visualization 183 requested from by the user. The visualization 183 shows accurate values for product numbers, as determined by the database system 120 using the source data set 122a. In addition, the properties of the visualization 183 (e.g., the visualization type, structure, and visual properties) are set as determined by the computer system 110 based on analysis of the code or instructions 173 specifying data retrieval and data processing to be performed.

The user device 106 also presents the results summary 185. For example, referring to FIG. 2, the results summary 185 states, “The histogram visualization of how many different products are bought by different countries shows the following. There are four intervals of numbers of products. The interval with the great number of products is 11-20 products, at 6 countries. The interval with the least number of products is 31-40 products, at 3 countries.” Thus, in response to the user prompt “How many different products are bought by different countries,” the chatbot provided both the visualization 183, in the form of a histogram, and the results summary 185 that summarizes the data shown in the visualization 183.

The summary of the visualization 183, or the underlying results 176 represented in the visualization 183, can be presented along with a direct answer to the user's prompt 170. For example, the answer can show a list of countries and the number of different products bought by each country. In many cases, this would include a list of the countries with the highest different product count, such as the top five countries and the amount of different products for each. If the number of countries represented in the results 176 is very high, however, this listing of top results would omit the overall view, and the full list could not be presented without using a large amount of display area. As a result, the histogram shows important information about the distribution across the overall set of countries, giving a broader view of the results 176 than could be seen in a small set of top-ranking results.

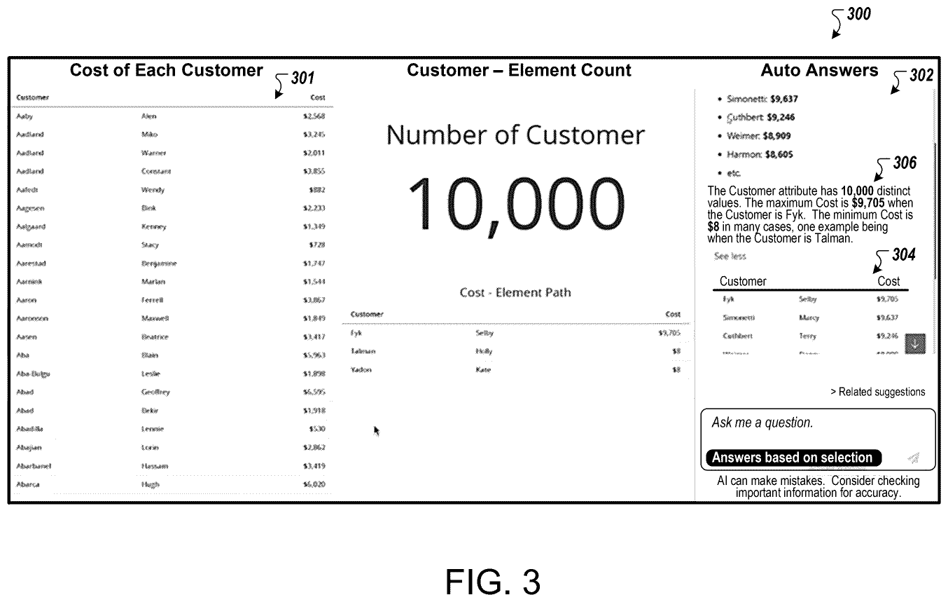

FIGS. 3 to 7 show example user interfaces showing functionality for providing visualizations and summaries of result data.

FIG. 3 shows an example user interface 300 that includes a table 301 entitled “Cost of Each Customer” and a chatbot pane 302 showing a conversation related to the table 301. In this example, the prompt received from a user was “Show the cost of each customer in a grid with statistical information about distinct element count.” The chatbot response includes a visualization that is a grid 304 showing customer names and associated costs. The type of visualization presented is a grid, due to the prompt specifying the visualization type of “grid.” The chatbot response includes a results summary 306. The results summary 306 provides the number of distinct values, the maximum cost, and the minimum cost for the data provided in the grid. Although the user explicitly asked for statistical information, the computer system 110 can be configured to generate and provide some information, such as maximum and minimum values, even without the user requesting it.

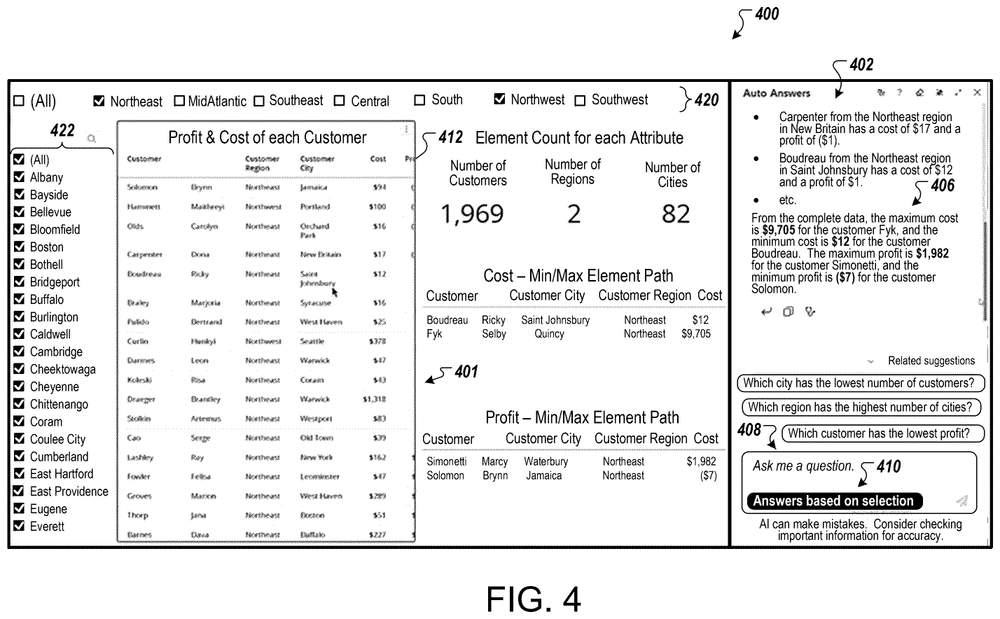

FIG. 4 shows an example user interface 400 that includes a table 401 entitled “Profit & Cost of each Customer” and a chatbot pane 402 showing a conversation related to the table 401. In this example, the prompt received from a user was “Show the customer, customer region, customer city, cost, profit in grid and statistical information about distinct element count.” The chatbot response can include a grid showing the requested information. The type of visualization is a grid, due to the prompt specifying the visualization type of “grid.” The chatbot response includes a results summary 406. The results summary 406 provides the maximum cost, the minimum cost, the maximum profit, and the minimum profit. In some examples, the results summary 406 can include an overview of the results. For example, the results summary may state, “The data provided includes information about customers, their regions, cities, costs, and profits.” In some examples, the results summary 406 can provide the number of distinct values for each attribute. For example, the results summary 406 may state, “The Customer attribute has 1969 distinct values. The Customer Region attribute has 2 distinct values. The Customer City attribute has 82 distinct values.”

The chatbot pane 402 includes a text entry field 408 in which user prompts can be input. The text entry field 408 includes a notification 410 stating “Answers based on selection.” The notification 410 indicates that answers provided by the chatbot are based on the user selection of the table 401. The user selection of the table 401 is indicated by the outline 412 of the table 401. The user selection of the table 401 designates the table 401 as being relevant to the conversion with the chatbot. In some examples, the user can close out the notification 410 in order to remove the designation of the table 401 as being relevant to the conversation. In some examples, the user can deselect the table 401 in order to remove the designation of the table 401 as being relevant to the conversation.

In some examples, elements from the data can be unselected by the user. For example, the table 401 may include a column of sensitive data, such as personal identifiable information. The user can unselect the column of sensitive data, so that the unselected information is not passed to the AI/ML service provider 130. The sensitive data will therefore not be included in the results, the visualization, or the results summary.

As shown in FIG. 4, various controls are provided for the user to specify whether to include or omit different types of data or different portions of a data set in the analysis obtained using the chatbot. The system can generate and provide the controls based on the context of the user prompt and the data set. For example, in FIG. 4, where the user provided the prompt ““Show the customer, customer region, customer city, cost, profit in grid and statistical information about distinct element count,” the system determines that location is a dimension for subdividing or grouping the data. In particular, after the first request 172 to the AI/ML model 132, the code or instructions 173 that are returned can indicate the data objects that are relevant to the user's prompt. For example, the code or instructions 173 can include a SQL statement or other code or instructions that references data objects (e.g., columns, metrics, attributes), from one or more data sets 122a-122n, representing a customer region and customer city. The computer system 110 can analyze the code or instructions 173, or results 176 later returned, to identify the dimensions (e.g., attributes) involved and use those to adjust the controls provided in the user interface 400.

In the example of FIG. 4, the computer system 110 identified customer region and customer city among the data objects in the code or instructions 173 from the AI/ML model 132, or additionally or alternatively identified them from the results 176 from the database system 120 or from a visualization specification or visualization data. The computer system 110 then caused values for the attributes of customer region and customer city to be presented with interactive checkbox controls that the user can interact with to select or deselect specific groups or categories records from being considered. For example, a set of controls 420 are provided for the customer region attribute, based on the user's mention of being interested in that type of data, even though the user did not ask specifically to have data filtered or clustered by that attribute. The controls 420 include values of the customer region populated from values identified in the database results obtained through the interaction with the chatbot or more generally from the customer region column referenced by the data of the chatbot, e.g., Northeast, MidAtlantic, Southeast, Central, South, Northwest, and Southwest. The user interface 400 also includes a set of controls 422 for values of the customer city attribute, which are provided because the attribute is mentioned or requested in the chatbot conversation, even though the user did not ask to filter or restrict the data based on this attribute. Example values of customer city shown include Albany, Bayside, Bellevue, and so on, each provided with a corresponding checkbox control so the user can specify whether records associated with those city values should be included or excluded from analysis requested in the chat conversation.

The computer system 110 can cause the types of dimensions or attributes by which the user can select or deselect data to be considered to change dynamically. For example, if the user submits a follow-up prompt that asks about different attributes, such as the quarter in which various transactions occurred, the computer system 110 can cause controls for different quarters (e.g., Q1 2024, Q4 2023, Q3 2023, etc.) to be provided to allow the user to selectively include data for quarters of interest. The new controls can be provided in addition to or in place of controls 420, 422 for other attributes or dimensions of the data.

As a result, the user's selections and settings on the user interface 400 outside the chatbot interface (e.g., the chatbot pane 402) are able to seamlessly adjust the scope of data that is considered by the chatbot (e.g., which is provided to or used by the corresponding AI/ML model(s) 132). The types of controls 420, 422 can be determined and displayed automatically by the system based on the data context of the current data set, user prompts, and chatbot responses, as well as based on the intermediate data generated in processing by the chatbot (e.g., code or instructions 173, results 176, visualization instructions 180, visualization data 182. In this way, the system integrates the chatbot with other user interfaces, with data scope controls addressing data attributes or dimensions selected dynamically as the context of the chat conversation proceeds, allowing different options to break down or filter the dataset and thus adjust the scope of data searched when generating chatbot results.

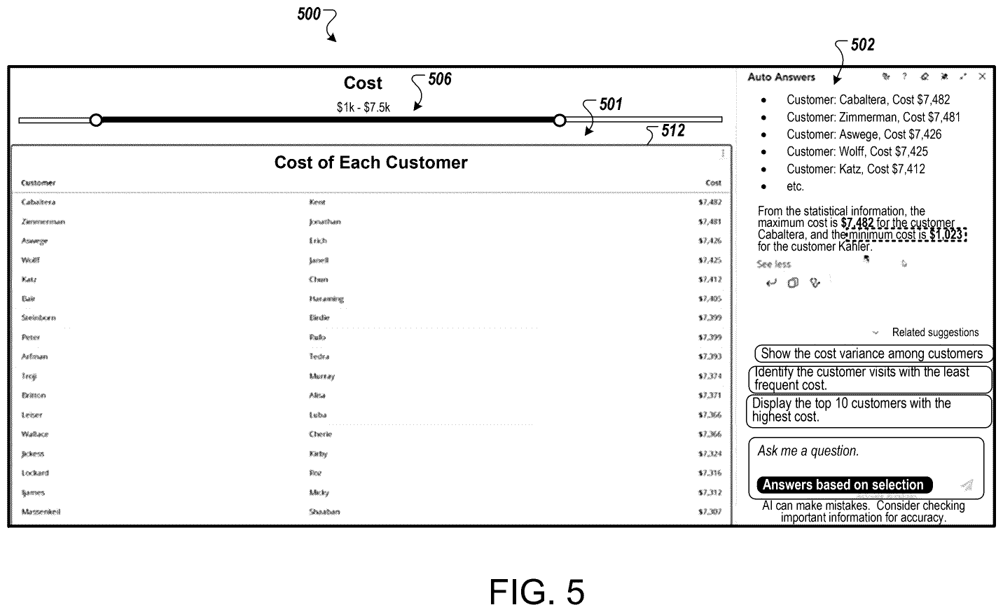

FIG. 5 shows an example user interface 500 that includes a table 501 and a filter 506. The filter 506 is applied to the table 501 such that the table 501 only shows data from the associate data tables that falls within the range specified by the filter 506. In the example of FIG. 5, the filter is a cost range between $1k and $7.5k. Therefore, the table 501 shows data related to customers for which the cost range fits in the filtered range. The table 501 is selected, as indicated by the outline 512. Therefore, chatbot responses provided in the chatbot pane 502 are based on the data in the selected table 501, e.g., describing the limited, filtered subset of data specified by the user. Here, the user prompt or question did not specifically ask for statistical information, but the computer system 110 included a direction to the AI/ML model 132 to include this information in the response.

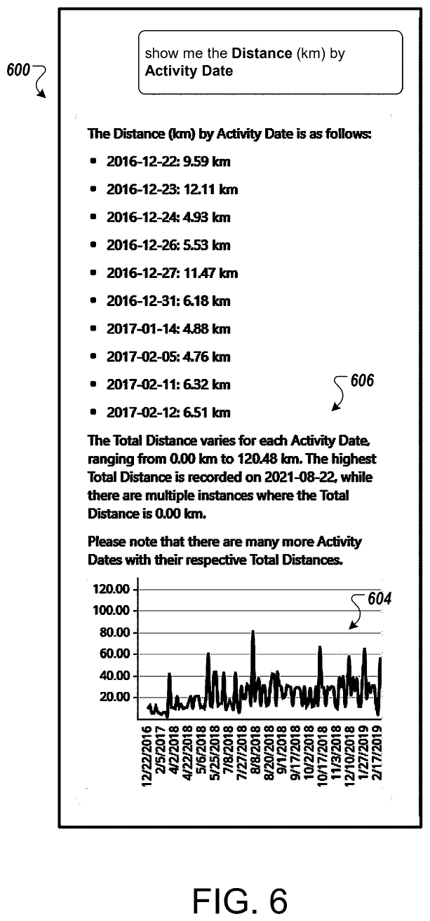

FIG. 6 shows an example chatbot pane 600. A user prompt received was “show me the Distance (km) by Activity Date.” The chatbot response includes a line graph 604 of distances by activity date. In this example, the prompt did not specify the type of visualization. The computer system 110 selects to show the information in a line graph visualization type. For example, the computer 110 may select to show the information in a visualization of a line graph based on one or more rules. The rules may specify, for example, that a line graph is the default visualization type when the x-axis is a value of time. The chatbot pane 600 includes a results summary 606. The results summary 606 states the maximum and minimum distance for each activity date. The results summary 606 states the date of the maximum distance. The results summary 606 states the maximum and minimum distances as a results of the second request 184 that was sent to the AI/ML service provider 130. The second request 184 included a request for maximum and minimum values, even though the user prompt did not request maximum and minimum values.

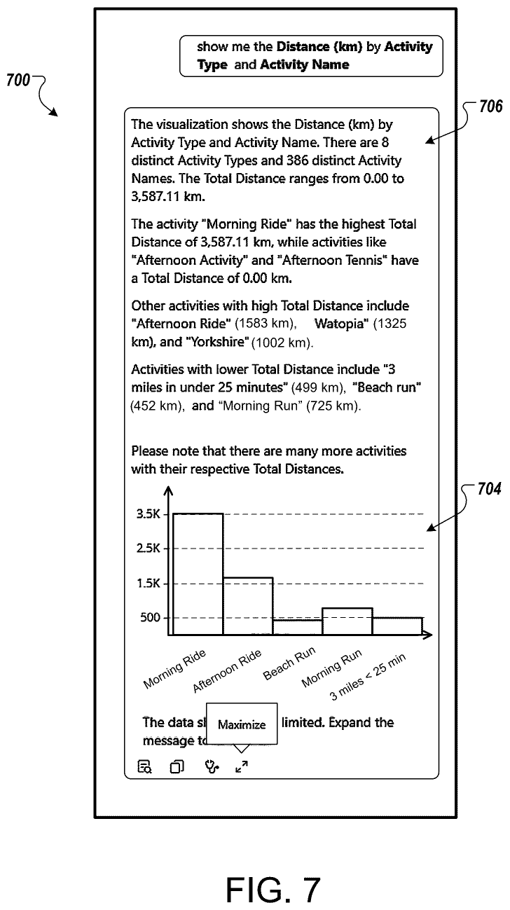

FIG. 7 shows an example chatbot pane 700. A user prompt received was “show me the Distance (km) by Activity Type and Activity Name.” The chatbot response includes a histogram 704 of distances by activity type. In this example, the prompt did not specify the type of visualization. The computer system 110 selects to show the information in a histogram visualization type. For example, the computer 110 may select to show the information in a visualization of a histogram based on the results satisfying one or more criteria. The criteria can include, for example, a minimum number of attributes in the result data, a maximum number of attributes in the result data, a minimum number of data values in the result data, a maximum number of data values in the result data, a minimum number of attributes per metric value in the result data, a maximum number of attributes per metric value in the result data, a maximum range of values in the result data, a minimum range of values in the result data, or any combination of these.

In some examples, the system can apply rules to determine a default type of visualization for various types of prompts and/or data results. The rules may specify, for example, that a histogram is the default visualization type when the x-axis values are multiple different categories, and there are multiple data entries for each of the multiple categories. Another example rule may state that a histogram is the default visualization type when the prompt includes a request for a distribution.

In some examples, the prompt specifies a requested type of visualization. The system can evaluate the prompt, the results, or both to determine whether the requested type of visualization is appropriate. In response to determining that the requested type of visualization is appropriate, the system can generate the requested type of visualization. In response to determining that the requested type of visualization is not appropriate, the system can provide a response to the user stating that the requested type of visualization cannot be generated. The system can select a different type of visualization based on selection criteria, and can generate the selected type of visualization.

The chatbot pane 700 includes a results summary 706. The results summary 706 states the number of activity types and activity names. The results summary states the maximum and minimum distances and their corresponding activity type. The results summary 706 lists several activity types with high distances, and several activity types with low distances.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by one or more computers, the method comprising:
receiving, by the one or more computers, a user prompt comprising text that includes a natural language statement from a user;
obtaining, by the one or more computers, code or instructions generated by one or more artificial intelligence and/or machine learning (AI/ML) models to retrieve, from a data source, data specified by the natural language statement in the user prompt;
retrieving, by the one or more computers, the data from the database system based on the code or instructions;
sending, by the one or more computers, a request for the one or more AI/ML models to summarize the retrieved data, wherein the request includes (i) the user prompt and (ii) an additional instruction for information to include in the summary that is not requested in the user prompt;
receiving, by the one or more computers, a summary of the retrieved data that the one or more AI/ML models generated in response to the request; and
providing, by the one or more computers, a response to the user prompt that includes (i) visualization data for display, wherein the visualization data is displayable to describe the retrieved data from the data source and (ii) the summary of the retrieved data that the one or more AI/ML models generated.

2. The method of claim 1, wherein the request for the one or more AI/ML models to summarize the retrieved data includes a request for statistical information related to the retrieved data, the summary of the retrieved data including the statistical information provided by the one or more AI/ML models in response to the request.

3. The method of claim 2, wherein the retrieved data comprises a data series; and
wherein the request for statistical information comprises a request for the one or more AI/ML models include in the summary an indication of a maximum value of the data series and a minimum value of the data series, wherein the user prompt does not request the maximum and minimum value to be provided.

4. The method of claim 1, comprising providing a visualization that indicates amounts of items for each of multiple different intervals in a range of values, wherein the visualization is provided based on at least one of (i) analysis of the user prompt or (ii) analysis of the retrieved results.

5. The method of claim 4, wherein the visualization is provided based on at least one of:
a determination whether the retrieved data includes values for a dimension across which aggregation can be performed; and
a determination that the retrieved data includes a number of data points, attributes, and/or metrics that is within a predetermined range.

6. The method of claim 1, comprising:
determining one or more visualization properties for the visualization data, wherein the retrieved data is presented according to the one or more visualization properties.

7. The method of claim 6, comprising determining the one or more visualization properties for the visualization data based on the code or instructions generated by the one or more AI/ML models.

8. The method of claim 6, comprising determining the one or more visualization properties for the visualization data based on the retrieved data from the database system.

9. The method of claim 6, wherein the one or more visualization properties specify a visualization type, the visualization type comprising one of a bar graph, line graph, pie chart, heat map, geographical map, or histogram.

10. The method of claim 9, wherein determining the one or more visualization properties comprises evaluating the retrieved data using selection criteria for each of multiple visualization types, and selecting the visualization type from the multiple visualization types based on the evaluation of the retrieved data using the selection criteria.

11. The method of claim 9, wherein the user prompt specifies a particular visualization type, the method comprising:
determining that the retrieved data satisfies criteria for being represented by the particular visualization type; and
in response, generating the visualization data to present the retrieved data in the particular visualization type.

12. The method of claim 9, wherein the user prompt specifies a particular visualization type, the method comprising:
determining that the retrieved data does not satisfy criteria for being represented by the particular visualization type; and
in response, generating a message indicating that the retrieved data does not satisfy the criteria for being represented by the particular visualization type and generating the visualization data to present the retrieved data in a visualization type that is different from the particular visualization type.

13. The method of claim 6, wherein the one or more visualization properties specify at least one of a visualization type, a label for a visualization or a portion of the visualization, a data series to be represented in the visualization, a layout of the visualization, or formatting of the visualization.

14. The method of claim 1, wherein obtaining the code or instructions generated by the one or more AI/ML models comprises:
generating an initial request for the one or more AI/ML models to generate the code or instructions to retrieve, from the data source, the data specified by the natural language statement in the user prompt;
sending the initial request to be processed by the one or more AI/ML models; and
receiving the code or instructions generated by the one or more AI/ML models in response to the initial request.

15. The method of claim 1, wherein the data source comprises one or more data tables, and wherein the code or instructions specify one or more rows of data to retrieve and calculations using data from the one or more rows that generate values to be represented in the visualization data.

16. A system comprising:
one or more computers; and
one or more non-transitory computer-readable media storing instructions that are operable, when executed by the one or more computers, to cause the one or more computers to perform operations comprising:
receiving, by the one or more computers, a user prompt comprising text that includes a natural language statement from a user;
obtaining, by the one or more computers, code or instructions generated by one or more artificial intelligence and/or machine learning (AI/ML) models to retrieve, from a data source, data specified by the natural language statement in the user prompt;
retrieving, by the one or more computers, the data from the database system based on the code or instructions;
sending, by the one or more computers, a request for the one or more AI/ML models to summarize the retrieved data, wherein the request includes (i) the user prompt and (ii) an additional instruction for information to include in the summary that is not requested in the user prompt;
receiving, by the one or more computers, a summary of the retrieved data that the one or more AI/ML models generated in response to the request; and
providing, by the one or more computers, a response to the user prompt that includes (i) visualization data for display, wherein the visualization data is displayable to describe the retrieved data from the data source and (ii) the summary of the retrieved data that the one or more AI/ML models generated.

17. The system of claim 16, wherein the request for the one or more AI/ML models to summarize the retrieved data includes a request for statistical information related to the retrieved data, the summary of the retrieved data including the statistical information provided by the one or more AI/ML models in response to the request.

18. The system of claim 17, wherein the retrieved data comprises a data series; and
wherein the request for statistical information comprises a request for the one or more AI/ML models include in the summary an indication of a maximum value of the data series and a minimum value of the data series, wherein the user prompt does not request the maximum and minimum value to be provided.

19. The system of claim 16, comprising providing a visualization that indicates amounts of items for each of multiple different intervals in a range of values, wherein the visualization is provided based on at least one of (i) analysis of the user prompt or (ii) analysis of the retrieved results.

20. One or more non-transitory computer-readable media storing instructions that are operable, when executed by one or more computers, to cause the one or more computers to perform operations comprising:
receiving, by the one or more computers, a user prompt comprising text that includes a natural language statement from a user;
obtaining, by the one or more computers, code or instructions generated by one or more artificial intelligence and/or machine learning (AI/ML) models to retrieve, from a data source, data specified by the natural language statement in the user prompt;
retrieving, by the one or more computers, the data from the database system based on the code or instructions;
sending, by the one or more computers, a request for the one or more AI/ML models to summarize the retrieved data, wherein the request includes (i) the user prompt and (ii) an additional instruction for information to include in the summary that is not requested in the user prompt;
receiving, by the one or more computers, a summary of the retrieved data that the one or more AI/ML models generated in response to the request; and
providing, by the one or more computers, a response to the user prompt that includes (i) visualization data for display, wherein the visualization data is displayable to describe the retrieved data from the data source and (ii) the summary of the retrieved data that the one or more AI/ML models generated.
